(19) United States
(12) Patent Application Publication
(10) Pub. No.: US 2008/0273592 A1
(43) Pub. Date: Nov. 6, 2008

(54) Video Encoding and Decoding

(75) Inventors: Petrus Desiderius Victor Van Der Stok, Eindhoven (NL); Dmitri Jarnikov, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/097,951

(22) PCT Filed: Dec. 18, 2006
(86) PCT No.: PCT/IB06/54918

§ 371 Date: Jun. 18, 2008

(30) Foreign Application Priority Data
Dec. 21, 2005 (EP) 05112623.3

(51) Int. Cl. H04B 1/66

(52) U.S. Cl. 375/240.01; 375/E07.001

(57) ABSTRACT

A method of producing encoded video data (DV) comprises the steps of: collecting video data (VS), producing a tag (T) identifying the collected video data, encoding the collected video data so as to produce at least two sets of encoded data (BL, EL1) representing different video quality levels, and attaching the tag (T) to each set of encoded video data. The tag is preferably unique and may be derived from the collected video data.

The present invention relates to video encoding and decoding. More in particular, the present invention relates to a device and a method for encoding video data constituting at least two layers, such as a base layer providing basic video quality and an enhancement layer providing additional video quality.

It is well known to encode video data, such as video streams or video frames. The video data may represent moving images or still images, or both. Video data are typically encoded before transmission or storage to reduce the amount of data. Several standards define video encoding and compression, some of the most influential being MPEG-2 and MPEG-4 (see http://www.chiariglione.org/mpeg/).

The MPEG standards define scalable video, that is video encoded in at least two layers, a first or base layer providing low-quality (e.g. low resolution) video and a second or enhancement layer allowing higher quality (e.g. higher resolution) video when combined with the base layer. More than one enhancement layer may be used.

Several video channels may be transmitted from different sources and be processed at a given destination at the same time, each channel representing an individual image or video sequence. For example, a first video sequence sent from a home storage device, a second video sequence broadcast by a satellite operator, and a third video sequence transmitted via the Internet may all be received by a television set, one video sequence being displayed on the main screen and the two other video sequences being displayed on auxiliary screens, for example as Picture-in-Picture (PiP). As each channel typically comprises two or more layers, large numbers of video layers may be transmitted simultaneously.

The destination can activate as many decoders as there are video layers. Each decoder instance, that is each activation of a decoder for a given layer, can be realized with a separate processor at the destination (parallel decoder instances). Alternatively, each decoder instance may be realized at different points in time, using a common processor (sequential decoder instances).

The decoders receiving multiple layers need to be able to determine the relationship between base layers and enhancement layers: which enhancement layers belong to which base layer. At the data packet level a provision may be made using packet identifiers (PIDs) which identify each packet in a data stream as a part of the particular stream. However, when multiple video streams are received by a decoding device, the relationship between base layers and enhancement layers are undefined, and the decoding of the video streams at the desired quality level is impossible.

It is noted that the well-known MPEG-4 standard mentions elementary stream descriptors which include information, such as a unique numeric identifier (Elementary Stream ID), about the source of the stream data. The standard suggests using references to these elementary stream descriptors to indicate dependencies between streams, for example to indicate dependence of an enhancement stream on its base stream in scalable object representations. However, the use of these elementary stream descriptors for dependence indication is limited to objects, which may not be defined in typical video data, in particular when the data are in a format according to another standard. In addition, elementary stream descriptors can only be used in scalable decoders which are in accordance with the MPEG-4 standard. In practice, these relatively complex scalable decoders are often replaced with multiple non-scalable decoders. This, however, precludes the use of elementary stream descriptors and their dependence indication.

It is an object of the present invention to overcome these and other problems of the Prior Art and to provide a device for and a method of encoding video which allows the relationship between a first layer and any second layers to be monitored and maintained.

Accordingly, the present invention provides a method of producing encoded video data, the method comprising the steps of:

collecting video data,

producing a tag identifying the collected video data,

encoding the collected video data so as to produce at least two sets of encoded data representing different video quality levels, and

attaching the tag to each encoded video data.

By producing a tag which identifies the collected video data, and attaching the tag to each set of encoded video data, the sets can be identified by their common tag. That is, the common tag makes it possible to determine which enhancement layers (or layer) belong to a given base layer.

The tag or identifier is preferably unique so as to avoid any possible confusion with another, identical tag. Of course uniqueness is limited in practice by the available number of bits and any other constraints that may apply, but within those constraints any duplication of a tag is preferably avoided. It is therefore preferred that the tag is uniquely derived from the collected data, for example using a hash function or any other suitable function that produces a single value on the basis of a set of input data. Alternatively, the tag may assume a counter value, a value derived from a counter value, or a random number. When random numbers are used, measures are preferably taken to avoid any accidental duplication of the tag.

Instead of a single tag identifying a certain video channel or video stream, a plurality of interrelated tags could be used. Each tag could, for example, comprise a fixed, common part and a variable, individual part, the variable part for example being a sequence number. The tag or tags could also comprise a set of data descriptors. Fingerprinting techniques which are known per se can be used to form tags.

Attaching the tag to the collected data may be achieved in various ways. It is preferred that the tag is appended to or inserted in the encoded data at a suitable location, or that the tag is inserted in a data packet in which part or all of the encoded data is transmitted. In MPEG compatible systems, the tag could be inserted into the “user data” section of a data packet or stream, such as e.g. provided in MPEG4.

The present invention also provides a computer program product for carrying out the method as defined above. A computer program product may comprise a set of computer executable instructions stored on a data carrier, such as a CD or a DVD. The set of computer executable instructions, which allow a programmable computer to carry out the method as defined above, may also be available for downloading from a remote server, for example via the Internet.

The present invention additionally provides a device for producing encoded video data, the device comprising:

a data collection unit for collecting video data,

a video analysis unit producing a tag identifying the collected video data,

an encoding unit for encoding the collected video data so as to produce at least two sets of encoded data representing different video quality levels, and

a data insertion unit for attaching the tag to each set of encoded video data.

The video analysis unit is preferably arranged for producing a substantially unique tag which may be derived from the collected video data. The tag is attached to each set of output data (encoded video data), such that the relationship of the sets may readily be established. By attaching the tag (or tags) to the data, any dependence upon data packets or other transmission format is removed.

The present invention also provides video system, comprising a device as defined above, as well as a signal comprising a tag as defined above.

The present invention will further be explained below with reference to exemplary embodiments illustrated in the accompanying drawings, in which:

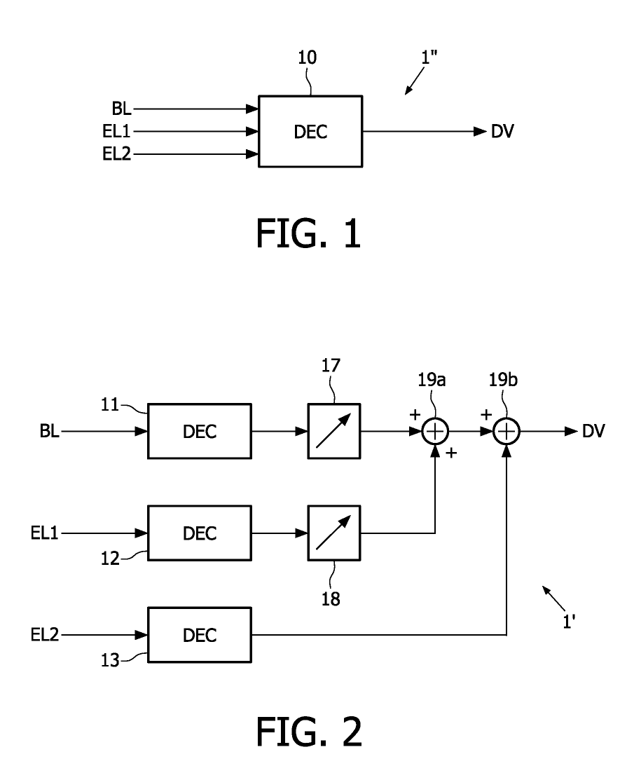

FIG. 1 schematically shows a first embodiment of a multiple layer video decoding device according to the Prior Art.

FIG. 2 schematically shows a second embodiment of a multiple layer video decoding device according to the Prior Art.

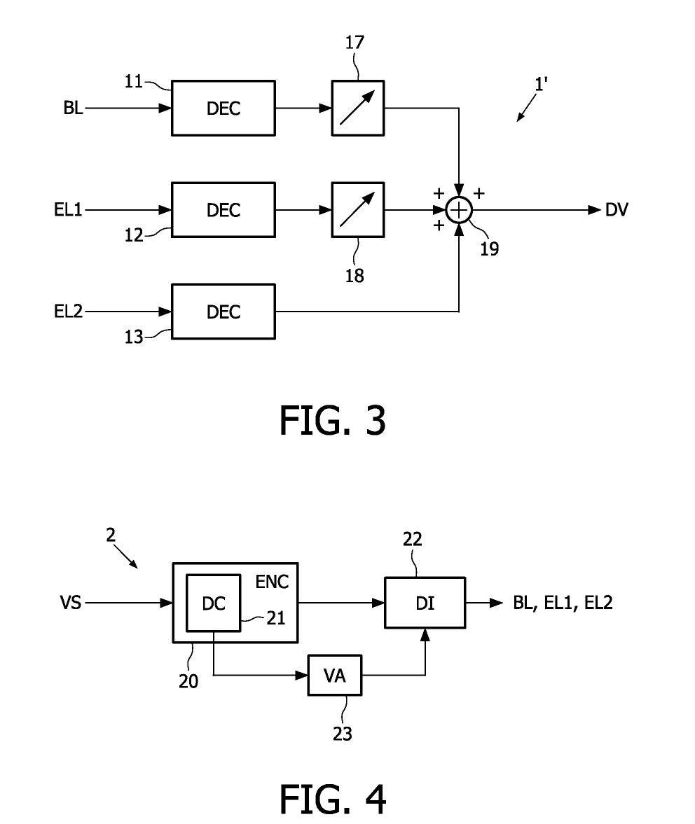

FIG. 3 schematically shows a third embodiment of a multiple layer video decoding device according to the Prior Art.

FIG. 4 schematically shows a first embodiment of a video encoding device according to the present invention.

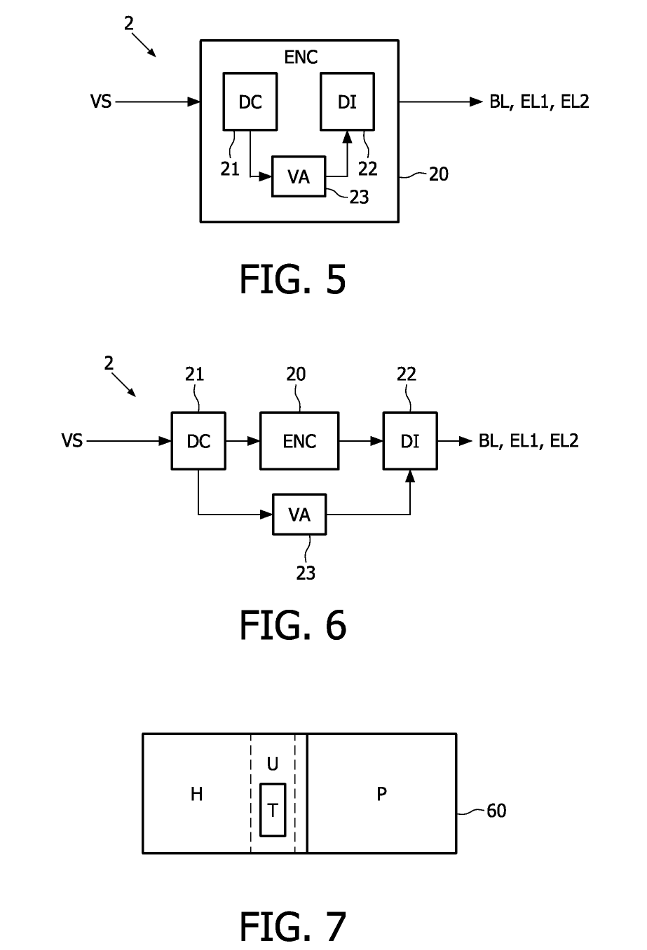

FIG. 5 schematically shows a second embodiment of a video encoding device according to the present invention.

FIG. 6 schematically shows a third embodiment of a video encoding device according to the present invention.

FIG. 7 schematically shows a data element for transmitting or storing scalable video according to the present invention.

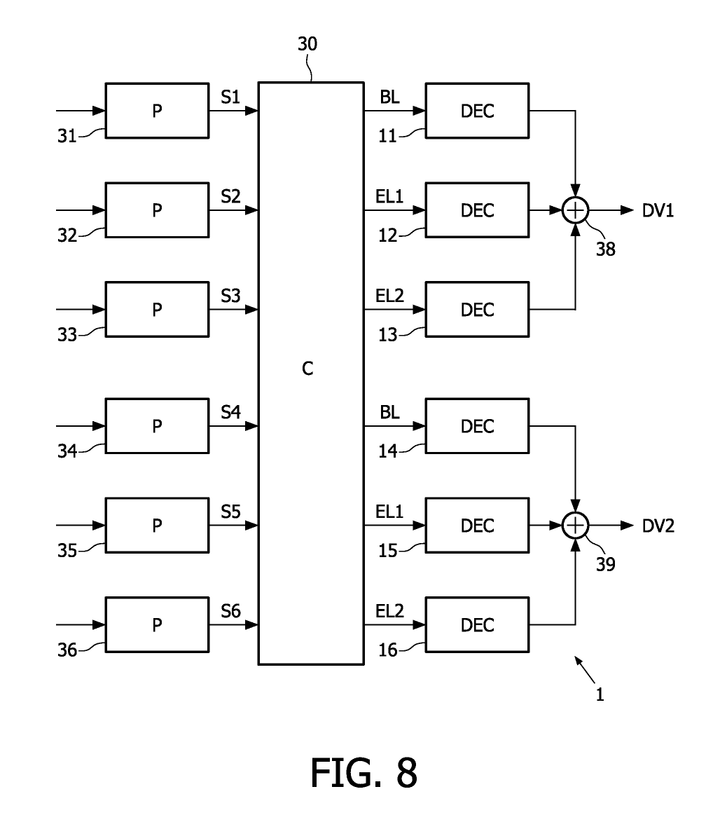

FIG. 8 schematically shows a first embodiment of a decoding device according to the present invention.

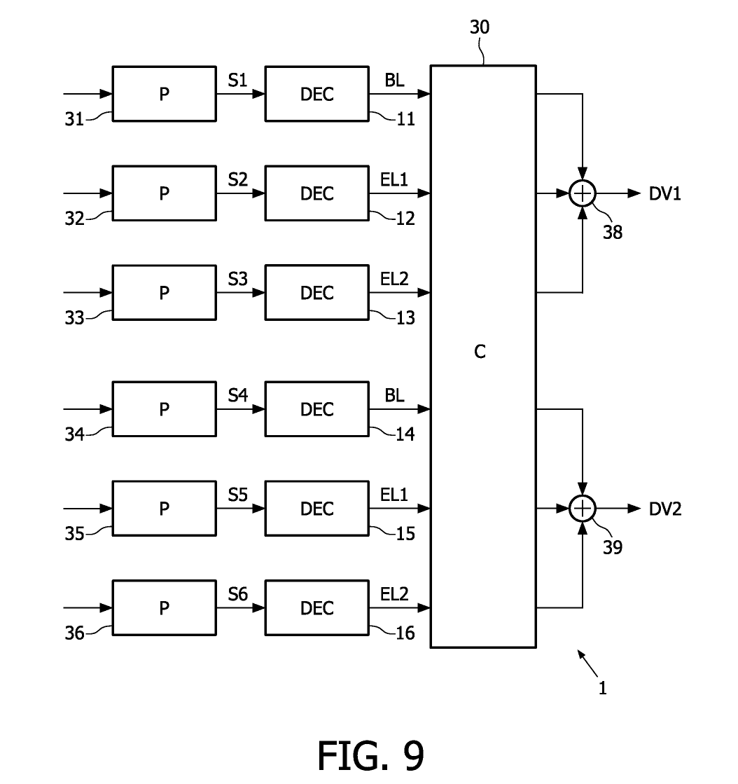

FIG. 9 schematically shows a second embodiment of a decoding device according to the present invention.

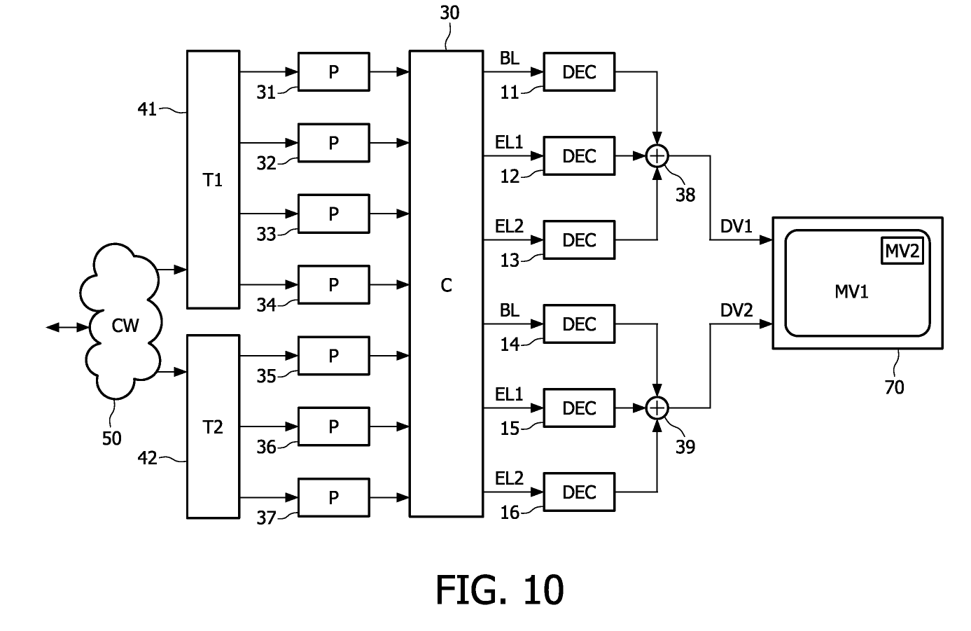

FIG. 10 schematically shows a first embodiment of a video system comprising a decoding device according to the present invention.

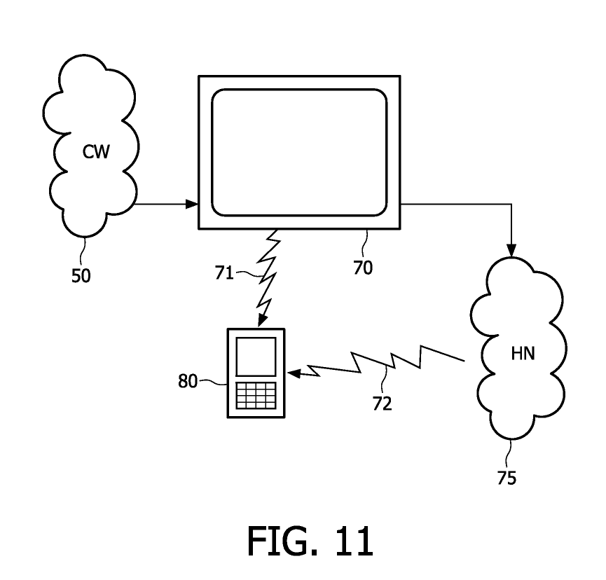

FIG. 11 schematically shows a second embodiment of a video system comprising a decoding device according to the present invention.

The Prior Art video decoding device 1″ schematically shown in FIG. 1 comprises a single integrated decoding (DEC) unit 10 having three input terminals for receiving the input signals BL (“Base Layer”), EL1 (“Enhancement Layer 1”) and EL2 (“Enhancement Layer 2”) which together constitute a scalable encoded video signal. Such integrated video decoding units are defined in, for example, the MPEG-4 standard, and are relatively difficult to implement. For this and other reasons, in practice integrated video decoders are replaced with composite decoders, such as illustrated in FIGS. 2 and 3.

The composite Prior Art video decoder 1′ schematically illustrated in FIG. 2 comprises three distinct video decoding (DEC) units 11, 12 and 13 for decoding the input signals BL, EL1 and EL2 respectively. The decoded video signals BL and EL1 are upsampled, if necessary, in upsampling units 17 and 18 respectively, which are then combined in a first combination unit 19a. The highest level input signal (enhancement layer) EL2 is, in the embodiment shown, not upsampled but is combined with the upsampled and combined signals BL and EL1 in a second combination unit 19b to produce a decoded video (DV) output signal.

Alternatively, only a single combination unit 19 may be used to combine the decoded and upsampled signals BL, EL1 and EL2, as illustrated in FIG. 3. It is noted that in some embodiments, the highest level input signal EL2 may be upsampled as well, however, this is not the case in the example of FIG. 3.

The decoding devices 1′ of FIGS. 2 and 3 offer the advantage of being relatively simple and can be implemented more economically than the device 1″ of FIG. 1. However, the devices 1′ of FIGS. 2 and 3 are typically not capable of providing advanced features, such as tracking the interrelationship of objects, as defined in the MPEG-4 standard.

To solve this problem, the invention provides an encoding device capable of providing tags which allow the mutual relationship between input signals to be monitored and checked. The present invention also provides a video decoding device capable of detecting any tags indicative of related input signals.

The video encoding device 2 shown merely by way of non-limiting example in FIG. 4 comprises an encoding unit 20, which may be a conventional encoding (ENC) unit receiving an input video stream VS and producing a layered (that is, scalable) encoded video output signal comprising the constituent signals BL, EL1 and EL2. The encoding unit 20 comprises a data collection (DC) unit 21 which is arranged for collecting the data to be encoded.

In contrast to conventional encoding units, the data collection unit 21 of FIG. 4 passes collected data not only to the appropriate parts of the encoding unit 20, but also to a video analysis (VA) unit 23. The video analysis unit 23 produces a tag which uniquely, or substantially uniquely, identifies the video stream VS. Although the video analysis unit 23 could comprise a counter or a random number generator to produce an appropriate tag, the tag is preferably derived from the collected data so as to produce a unique number or other identifier, as will be explained later in more detail.

A data insertion (DI) unit 22 receives both the encoded data from the encoding unit 20 and the tag (or tags) from the video analysis unit 23, and inserts the tag into the output signals BL, EL1 and EL2. This insertion involves attaching the tags to the encoded data rather than, or in addition to, inserting the tag in a packet header or other transmission-specific information. The tag is common to the signals BL, EL1 and EL2 and contains information identifying the fact that the signals are related. The tag may, for example, contain information identifying the source of the video data.

The video analysis unit 23 may contain a parser which parses video data, including any associated headers, in a manner known per se. If suitable data corresponding to a given format (for example so-called user data in MPEG-4) is present, a tag is extracted from the data. Using the example of user data, the video stream is parsed until the user data header start code (0x00, 0x00, 0x0, 0xB2) is encountered. Then all data is read until the next start code (0x00, 0x00, 0x01), the intermediate data is user data. If this data complies with a given (predetermined) tag format, the tag information may be extracted from this data.

Deriving or extracting the tag from the video stream may be achieved by producing and/or collecting special features of the video stream, in particular the video content. These features could include color information (such as color histograms, a selection of particular DCT coefficients of a selection of blocks within scattered positions in the image, dominant color information, statistical color moments, etc.), texture (statistical texture features such as edge-ness or texture transforms, structural features such as homogeneity and/or edge density), and/or shape (regenerative features such as boundaries or moments, and/or measurement features such as perimeter, corners and/or mass center). Other features may also be considered. E.g. a rough indication of the motion within a shot may be enough to relatively uniquely characterize it. Additionally, or alternatively, the tag information may be derived from the video stream using a special function, such as a so-called “hash” function which is well known in the field of cryptography. So-called fingerprinting techniques, which are known per se, may also be used to derive tags. Such techniques may involve producing a “fingerprint” from, for example, the DC components of image blocks, or the (variance of) motion vectors.

It is preferred that the format of the tag complies with the stream syntax according to the MPEG-2 and/or MPEG-4 standards, and/or other standards that may apply. For example, if the tag is accommodated in a header, such as a user data header, it should not contain a subset that can be recognized by a decoder as an MPEG start code, and a byte sequence of 0x00, 0x00, 0x01 is in that case not permitted. In order to avoid such a byte sequence, a string representation of the collected information is preferred. A non-limiting example of producing a tag is given below.

If color histograms are used for tag creation, for example, the number of appearances of a particular color value in a video frame is recorded and placed into a histogram bin (the number of bins defining the granularity of histograms). The histograms are then added and normalized over either the entire video stream or a predefined number of frames. The values thus obtained are converted from an integer representation into a string representation and the resulting string constitutes the core of the tag. In addition to this core a substring ‘BL00’ or ‘ELxx’ should be added to the beginning of the tag of a base layer or enhancement layer having a number xx respectively to identify the relationship between the layers.

To illustrate this example it is assumed that color histograms having ten bins are produced for a set of video data. The summed and normalized histogram data are, for example:

0.1127, 0.0888, 0.2302, 0.3314, 0.0345, 0.0835, 0.0600, 0.0235, 0.0297, 0.0056.

When converting these data into a string representation the leading zeroes are omitted but the points are preserved to indicate value boundaries, yielding:

‘0.1127.0888.2302.3314.0345.0835.0600.0235.0297.0056’.

For the base layer (BL), the resulting tag is:

‘BL00.1127.0888.2302.3314.0345.0835.0600.0235.0297.0056’, for the first enhancement layer (EL1):

‘EL01.1127.0888.2302.3314.0345.0835.0600.0235.0297.0056’, and for the second enhancement layer (EL2):

‘EL02.1127.0888.2302.3314.0345.0835.0600.0235.0297.0056’.

Similarly, further tags can be produced if any additional layers are present.

In the embodiment of FIG. 4, the video analysis unit 23 is part of the encoding device 2 but external to the encoding unit 20. In the embodiment of FIG. 5, both the data insertion unit 22 and the video analysis unit 23 are incorporated in the encoding unit 20. In the embodiment of FIG. 6, both the data collection unit 21, the data insertion unit 22, and the video analysis unit 23 are external to the encoding unit 20. It will be understood that the encoding device 2 may be implemented in hardware and/or in software.

The video data element 60 according to the present invention which is shown merely by way of non-limiting example in FIG. 7 comprises an element header H and a payload P. If the data element 60, which may for example be a picture, a group of pictures (GoP) or a video sequence, complies with the MPEG-2 or MPEG-4 standard, it has a user data section U. In accordance with a further aspect of the present invention, a tag T containing video source information may be inserted in this user data section. As a result, in the example shown the tag T is part of the header, although in some embodiments the tag may also be inserted into the payload. The advantage of using space in the header is that the payload can be normal encoded video data.

In modern video encoding and transmission systems (where transmission should be read generically as also comprising transmission to e.g. a storage medium), typically a number of nested headers are attached to a packet (e.g. for network transmission, those packages that successively belong to each other). The information in these headers may however get lost in a number of systems, e.g. in a single system near to the final decoding when all the other headers have been stripped, and most certainly in distributed systems, in which some of the decoding is done in a different apparatus, or even by a different content provider, or intermediary.

Therefore, it is important that information enabling association of video data belonging to each other (e.g. enhancement layers for a base layer, but also e.g. extra appendix signals to fill in black bars or go to another display ratio format, etc.) can be associated as long as possible, hence it has to be (additionally perhaps) encoded as close as possible to the payload encoding the actual video signal, preferably in the last video header to be decoded. It is preferred that each video data element 60 contains at least one tag according to the present invention.

Additional source information may be incorporated in the header H, such as a packet identification (PID) or an elementary stream identification (ESID). However, such source information may be lost when multiplexing or forwarding packets, while payload information should be preserved. As a result, the tag is preserved and allows the relationship between the various signals of scalable video to be identified.

A first embodiment of a video decoding device 1 according to the present invention is schematically illustrated in FIG. 8. In the embodiment shown, the device 1 comprises six parser (P) units 31 to 36, each receiving and outputting video streams S1-S6. In addition, the parser units extract tag information. These streams S1-S6 and the associated tag information are passed to a connector (C) unit 30. Based on the tag information, the connector unit 30 identifies each stream S1-S6 and passes (or dispatches) the stream to a matching decoder. In the embodiment of FIG. 8, two sets of decoders are shown: two decoders 11 for decoding the base layer BL, two decoders 12 for decoding the enhancement layer EL1, and two decoders 13 for decoding the enhancement layer EL2 of the respective video streams. Accordingly, the respective streams are each fed to the correct decoding unit, based upon the associated tag information. The corresponding layers are combined in combination units 38 and 39 to produce decoded video (DV) signals DV1 and DV2 respectively.

For example, the input stream S2 may contain the base layer (BL) of the second video signal DV2 and should be fed to the lower decoder 11. The tag information read by parser 33 is used for this purpose.

A second embodiment of a video decoding device 1 according to the present invention is schematically illustrated in FIG. 9. In the embodiment of FIG. 9, the device 1 also comprises six parser (P) units 31 to 36, each receiving and outputting video streams S1-S6 and tag information. These streams S1-S6 and the associated tag information are passed decoders 11-16 which output the layer streams BL, EL1 and EL2 for the video signals DV1 and DV2 and the associated tag information. Based upon the tag information, the connector unit 30 identifies each stream S1-S6 and passes the stream to a matching combination unit 38 or 39 to produce the decoded video signals DV1 and DV2 respectively. In the embodiment of FIG. 9, the layers BL, EL1 etc. are decoded before being fed to the connector unit 30, whereas in the embodiment of FIG. 8 the connector unit 30 processed encoded layers.

It is noted that the order in which the layers BL, EL1, etc. are shown in FIG. 9 is only exemplary. For example, the base layer BL output by the (first) decoder 11 could be the base layer of the second decoded video signal DV2. Similarly, the input stream S1 could equally well contain the encoded elementary layer EL1 of either DV1 or DV2.

Embodiments of the video decoding device 1 can be envisaged in which the tag information is produced by the decoding units (decoders) 11-16 and no separate parsers are provided.

A video system incorporating the present invention is schematically illustrated in FIG. 10. The video system comprises a video decoding device (1 in FIG. 8) which in turn comprises parsers 31-37, a connecting unit 30, decoders 11-16 and combination units 38-39. In addition, the video system comprises a television apparatus 70 capable of displaying at least two video channels simultaneously in screen sections MV1 and MV2, for example using the well-known Picture-in-Picture (PiP) technology, or side-by-side.

In the present example, the video system receives video streams from a communications network (CW) 50, which may be a cable television network, a LAN (Local Area Network), the Internet, or any other suitable transmission path or combination of transmission paths. It should be noted that some of the information could come from a first network type, say satellite, (e.g. the BBC1 program currently playing), whereas other information, such as perhaps further enhancement data for the BBC1 program, may be received over internet, e.g. via a different settobox. Video streams are received by two tuners 41 and 42 which each select a channel (comprising at least some of the layers for the programs rendered as MV1 and MV2 on the television apparatus 70). The first tuner (T1) 41 is connected to parsers 31-34, while the second tuner (T2) is connected to parsers 35-37. Each tuner 41, 42 passes multiple video streams to the parsers.

In accordance with the present invention, the video streams contain tags (identification data) identifying any mutual relationships between the streams. For example, a video stream could contain the tag EL2_ID0527, stating that it is an enhancement layer (second level) data stream having an identification 0527 (e.g. the teletubbies program).

Suppose for illustrative purposes that in the first channel (e.g. UHF 670+0−5 MHz) which tuner T1 is locked on comprises two layers (base and EL1) of a cooking program, currently viewed in MV2 subwindow, and the two first layers (base and EL1) of the teletubbies program viewed in MV1. The third layer of the teletubbies program (EL2) is transmitted in the second channel (e.g. VHF 150 MHz+0-5 MHz) and received via tuner 2. It also comprises two other program layers, e.g. a single layered news program, and perhaps some intranet or videophone data, which can currently be discarded as they are not displayed or otherwise used.

The connector can then by analyzing the tag correspondences connect to the adder the correct layers, so that not a teletubby ghost differential update signal is added to the cooking program images.

The corresponding video streams could then contain the tags BL_ID0527 and EL1_ID0527 (and EL3_ID0527, if a third level enhancement layer were present). The parsers detect these tags and based on the tag information, the connector unit 30 routes the video streams are routed to their corresponding decoder.

The tags could also indicate whether the video stream is encoded using spatial, temporal or SNR (Signal-Noise-Ratio) scalability. For example, a tag SEL2_ID0527 could indicate that the video stream corresponds with a spatially scalable enhancement layer (level 2) having ID number 0527. Similarly, TEL2_ID0527 and NEL2_ID0527 could indicate its temporally and SNR-encoded counterparts.

The system can be embodied in several different ways to learn about which tags exist. E.g. a table of available tags on one or more channels of one or more network connections can be transmitted at regular intervals, and then the system can make the appropriate associations for the programs currently watched. Or the system can be more dynamically in that it just analyses which tags come in via the different packets of the connected networks, and maintains an on-the-fly generated table. E.g. after some packets the system knows that there is a TAG=“teletubbies” (the string being generated by the content provider from inputted metadata), and after some more packets that apart from a BL_teletubbies and EL1_teletubbies, there is also a possibility to receive further enhancement data EL2_teletubbies via some input (e.g. by having one of the tuners sequentially scan a number of packets of all available connected channels, or by receiving metadata about what's available on the network channels, etc.).

A potential of the video system when spread over different apparatuses is illustrated by way of non-limiting example in FIG. 11, which comprises a digital television apparatus 70 in which a video decoding device (1 in FIGS. 8 and 9) according to the present invention is incorporated. The television apparatus 70 also receives (encoded) video streams from a communications network (CW) 50. Various channels could reach the television apparatus 70, or the network 50, via various transmission paths. One broadcasting station could use a cable network, whereas another station could transmit its programs via a satellite.

The television apparatus 70, or its video decoding device 1, transmits via a home network HN at least two video layers to another (e.g. portable) video display, e.g. in an intelligent remote control unit 80, such as the Philips Pronto® line of remote control units. One layer (e.g. BL) is transmitted directly form from the television apparatus, as indicated by the arrow 71, while the other layer (e.g. EL1) is transmitted via the home network (HN) 75, as indicated by the arrow 72. The base layer transmitted directly from the television set (arrow 71) may be an encoded (compressed) layer which may be decoded at the remote control unit 80, while the enhancement layer EL transmitted via the home network (arrow 72) may be a decoded normal video signal layer, needing no further decoding at the remote control unit. Again there need to be coordination so that the correct corresponding signals are added together in the pronto. E.g. typically the television 70 will check whether the two signals on the separate paths belong to each other, and if at any or several time instants there is also an indication of the tag T transmitted via the encompressed home network link, also the pronto can double check the correspondence with the tag T in the video header of the compressed data received.

The present invention is based upon the insight that the relationship between multiple video signals in a scalable video system needs to be indicated. The present invention benefits from the further insight that attaching a tag to the encoded video data allows this relationship to be established, even if it had been present in any other way, but removed.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. A method of producing encoded video data, the method comprising the steps of:
collecting video data (VS),
producing a tag (T) identifying the collected video data,
encoding the collected video data so as to produce at least two sets of encoded data (BL, EL1) representing different video quality levels, and
attaching the tag (T) to each set of encoded video data.

2. The method according to claim 1, wherein the tag (T) is derived from the collected video data (VS) and preferably involves fingerprinting techniques.

3. The method according to claim 1, wherein the tag is inserted into a “user data” section of a data packet or stream.

4. The method according to claim 1, wherein the tag (T) is unique.

5. A method of producing decoded video data, the method comprising the steps of:
parsing input video streams to detect tag information,
decoding each video stream in dependence of the detected tag information.

6. A method as claimed in claim 5, comprising the step of: associating different sets of encoded data (BL, EL1) representing different video quality levels, which have the same tag (T) or the same subpart of tag (T).

7. A computer program product for carrying out the method according to claim 1.

8. A device (2) for producing encoded video data, the device comprising:
a data collection unit (21) for collecting video data (VS),
a video analysis unit (23) producing a tag (T) identifying the collected video data,
an encoding unit (20) for encoding the collected video data so as to produce at least two sets of encoded data (BL, EL1) representing different video quality levels, and
a data insertion unit (22) for attaching the tag (T) to each set of encoded video data.

9. The device according to claim 8, wherein the video analysis unit (23) is arranged for deriving the tag (T) from the collected video data.

10. A device (1) for producing decoded video data (DV), the device comprising:
parsing units (31-36) for parsing input video streams to detect tag information,
decoding units (11-13) for decoding each input video stream, and
a connecting unit (30) for passing each input video stream to a decoding unit in dependence of the detected tag information.

11. A video system, comprising a video encoding device (2) according to claim 8.

12. A signal comprising a tag (T) for identifying mutually related video streams.

13. A signal as claimed in claim 12, in which each video packet has in the after decoding last remaining video related packet header the tag (T) identifying that the packet belongs to corresponding sets of encoded data (BL,EL1) representing different video quality levels of a particular program or multimedia content item.

14. A data carrier on which the signal according to claim 12 is stored.
